(19) United States
(12) Patent Application Publication
(10) Pub. No.: US 2019/0130496 A1
(43) Pub. Date: May 2, 2019

(54) System, Method, and Computer Program Product for Providing Merchant-Based Social Networks

(71) Applicant: Visa International Service Association, San Francisco, CA (US)

(72) Inventors: Rajesh Kumar Aroli Veettil, Singapore (SG); Sachin Cherian Mathew, Singapore (SG); Shi Kai Khiew, Singapore (SG)

(21) Appl. No.: 15/800,285

(22) Filed: Nov. 1, 2017

(51) Int. Cl. G06Q 50/00; H04L 29/06

(52) U.S. Cl. CPC G06Q 50/01; G06Q 20/202; H04L 63/104

(57) ABSTRACT

Provided is a computer-implemented method for providing a merchant-based social network for at least one merchant. The method may include determining whether to grant access to a group merchant network for a first merchant based on qualification data associated with the group merchant network, determining identification data associated with an identifier of at least one second merchant of the group merchant network based on at least one merchant alignment parameter, communicating the identification data associated with the identifier of at least one second merchant, receiving a selection of the at least one second merchant, communicating an invitation request message based on receiving the selection of the at least one second merchant, receiving an invitation response message, and granting access to the individual merchant network associated with the first merchant for the at least one second merchant. A system and computer program product are also disclosed.

### BACKGROUND OF THE INVENTION

### 1. Field of the Invention

This invention relates generally to systems, devices, products, apparatus, and methods that generate social networks and, in one particular embodiment, to a system, product, and method for providing merchant-based social networks.

### 2. Technical Considerations

Social media services may include computer-implemented technologies that facilitate the creation and sharing of information, ideas, career interests, and other forms of expression via a virtual social space. Users typically access social media services via web-based technologies on desktop computers and laptops, or download services that offer social media functionality to a user's mobile device. Social media services may facilitate the development of social networks by connecting a user's profile with profiles of other individuals or groups.

A merchant may join a social network from a social media service provider, such as Facebook®, to advertise goods and services offered by the merchant. The merchant may also join the social network to identify other merchants that are of interest to the merchant and/or determine information regarding the other merchants.

However, the merchant may not be able to identify the other merchants that are of interest to the merchant and/or determine information regarding the other merchants. For example, the merchant may not be able to accurately determine information regarding all of the goods and services offered by another merchant.

### SUMMARY OF THE INVENTION

Accordingly, systems, devices, products, apparatus, and/or methods for providing merchant-based social networks are disclosed that overcome some or all of the deficiencies of the prior art.

According to a non-limiting embodiment, provided is a computer-implemented method for providing a merchant-based social network for at least one merchant. The method comprises determining, with at least one processor, qualification data associated with a group merchant network for a first merchant based on an access request message from the first merchant; determining, with at least one processor, whether to grant access to the group merchant network for the first merchant based on determining the qualification data associated with the group merchant network; determining, with at least one processor, identification data associated with an identifier of at least one second merchant of the group merchant network based on at least one merchant alignment parameter; communicating, with at least one processor, the identification data associated with the identifier of at least one second merchant based on determining the identification data associated with the identifier of at least one second merchant; receiving, with at least one processor, a selection of the at least one second merchant; communicating, with at least one processor, an invitation request message based on receiving the selection of the at least one second merchant, wherein the invitation request message comprises an invitation for the at least one second merchant to join an individual merchant network associated with the first merchant; receiving, with at least one processor, an invitation response message after communicating the invitation request message, wherein the invitation response message comprises an indication that indicates whether the at least one second merchant will join the individual merchant network associated with the first merchant; granting, with at least one processor, access to the individual merchant network associated with the first merchant for the at least one second merchant based on the invitation response message; and wherein, by granting access to the individual merchant network associated with the first merchant: the at least one second merchant is authorized to cause a transaction offset associated with the first merchant to be generated, or the first merchant is authorized to cause a transaction offset associated with the at least one second merchant to be generated.

According to another non-limiting embodiment, provided is a system for providing a merchant-based social network for at least one merchant. The system comprising at least one processor programmed or configured to determine to grant access to a group merchant network for a first merchant based on qualification data associated with the group merchant network; determine identification data associated with an identifier of at least one second merchant of the group merchant network based on at least one merchant alignment parameter; communicate the identification data associated with the identifier of each merchant of a plurality of merchants of the group merchant network based on determining the identification data associated with the identifier of at least one second merchant; receive a selection of at least one second merchant of the plurality of merchants of the group merchant network; communicate an invitation request message based on receiving the selection of the at least one second merchant, wherein the invitation request message comprises an invitation for the at least one second merchant to join an individual merchant network associated with the first merchant; receive an invitation response message after communicating the invitation request message, wherein the invitation response message comprises an indication that indicates whether the at least one second merchant will join the individual merchant network associated with the first merchant; grant access to the individual merchant network associated with the first merchant for the at least one second merchant based on the invitation response message; and wherein, based on granting access to the individual merchant network associated with the first merchant, the at least one processor programmed or configured to: authorize the at least one second merchant to cause a transaction offset associated with the first merchant to be generated, and authorize the first merchant to cause a transaction offset associated with the at least one second merchant to be generated.

According to a further non-limiting embodiment, provided is a computer program product for providing a merchant-based social network for at least one merchant. The computer program product comprises at least one non-transitory computer-readable medium including one or more instructions that, when executed by at least one processor, cause the at least one processor to determine whether to grant access to the group merchant network for a first merchant based on qualification data associated with the group merchant network; determine identification data associated with an identifier of at least one second merchant of the group merchant network based on at least one merchant alignment parameter; communicate the identification data associated with the identifier of at least one second merchant based on determining the identification data associated with the identifier of at least one second merchant; receive a selection of the at least one second merchant; communicate an invitation request message based on receiving the selection of the at least one second merchant, wherein the invitation request message comprises an invitation for the at least one second merchant to join an individual merchant network associated with the first merchant; receive an invitation response message after communicating the invitation request message, wherein the invitation response message comprises an indication that indicates whether the at least one second merchant will join the individual merchant network associated with the first merchant; grant access to the individual merchant network associated with the first merchant for the at least one second merchant based on the invitation response message; and wherein, based on granting access to the individual merchant network associated with the first merchant, the one or more instructions further cause the at least one processor to authorize the at least one second merchant to cause a transaction offset associated with the first merchant to be generated, and authorize the first merchant to cause a transaction offset associated with the at least one second merchant to be generated.

Further embodiments or aspects are set forth in the following numbered clauses:

Clause 1: A computer-implemented method for providing a merchant-based social network for at least one merchant, the method comprising: determining, with at least one processor, qualification data associated with a group merchant network for a first merchant based on an access request message from the first merchant; determining, with at least one processor, whether to grant access to the group merchant network for the first merchant based on determining the qualification data associated with the group merchant network; determining, with at least one processor, identification data associated with an identifier of at least one second merchant of the group merchant network based on at least one merchant alignment parameter; communicating, with at least one processor, the identification data associated with the identifier of at least one second merchant based on determining the identification data associated with the identifier of at least one second merchant; receiving, with at least one processor, a selection of the at least one second merchant; communicating, with at least one processor, an invitation request message based on receiving the selection of the at least one second merchant, wherein the invitation request message comprises an invitation for the at least one second merchant to join an individual merchant network associated with the first merchant; receiving, with at least one processor, an invitation response message after communicating the invitation request message, wherein the invitation response message comprises an indication that indicates whether the at least one second merchant will join the individual merchant network associated with the first merchant; granting, with at least one processor, access to the individual merchant network associated with the first merchant for the at least one second merchant based on the invitation response message; and wherein, by granting access to the individual merchant network associated with the first merchant: the at least one second merchant is authorized to cause a transaction offset associated with the first merchant to be generated, or the first merchant is authorized to cause a transaction offset associated with the at least one second merchant to be generated.

Clause 2: The computer-implemented method of clause 1, wherein determining the qualification data associated with the group merchant network comprises: determining the qualification data associated with the group merchant network for the first merchant based on transaction data associated with a payment transaction involving the first merchant; and wherein determining whether to grant access to the group merchant network for the first merchant comprises: comparing the qualification data to qualification criteria based on determining the qualification data; determining that the qualification data corresponds to qualification criteria; determining to grant access to the group merchant network based on determining that the qualification data corresponds to qualification criteria.

Clause 3: The computer-implemented method of clauses 1 or 2, further comprising: communicating a notification message to the first merchant based on determining to provide access to the group merchant network for the first merchant, wherein the notification message comprises at least one of: group merchant network data associated with the first merchant, merchant location restriction data associated with the first merchant, merchant participation restriction data associated with the first merchant, or any combination thereof.

Clause 4: The computer-implemented method of any of clauses 1-3, further comprising: receiving a search request message from the first merchant, wherein the search request message includes the at least one merchant alignment parameter.

Clause 5: The computer-implemented method of any of clauses 1-4, further comprising: receiving the at least one merchant alignment parameter from the first merchant; and wherein determining the identification data associated with the identifier of the at least one second merchant of the group merchant network comprises: determining the identification data associated with the identifier of at least one second merchant of the group merchant network based on receiving the at least one merchant alignment parameter from the first merchant.

Clause 6: The computer-implemented method of any of clauses 1-5, wherein receiving the selection of the at least one second merchant comprises: receiving the selection of the at least one second merchant after communicating the identification data associated with the identifier of at least one second merchant.

Clause 7: The computer-implemented method of any of clauses 1-6, wherein granting access to the individual merchant network of the first merchant for the at least one second merchant comprises: receiving authorization data from the first merchant, wherein the authorization data comprises an indication that the first merchant authorizes the at least one second merchant to generate a transaction offset associated with the first merchant based on transaction offset data associated with the transaction offset from the at least one second merchant.

Clause 8: The computer-implemented method of any of clauses 1-7, wherein granting access to the individual merchant network of the first merchant for the at least one second merchant comprises: receiving authorization data from the first merchant, wherein the authorization data comprises an indication that the first merchant authorizes the at least one second merchant to generate a transaction offset associated with the first merchant based on transaction offset data associated with the transaction offset from the at least one second merchant.

Clause 9: The computer-implemented method of any of clauses 1-8, wherein determining the identification data associated with the identifier of the at least one second merchant of the group merchant network comprises: determining the identification data associated with the identifier of the at least one second merchant of the group merchant network based on the at least one merchant alignment parameter and the qualification data.

Clause 10: The computer-implemented method of any of clauses 1-9, further comprising: determining at least one of: group merchant network data associated with the at least one second merchant, merchant location restriction data associated with the at least one second merchant, merchant participation restriction data associated with the at least one second merchant, or any combination thereof; communicating, to the first merchant, at least one of: group merchant network data associated with the at least one second merchant, merchant location restriction data associated with the at least one second merchant, merchant participation restriction data associated with the at least one second merchant, or any combination thereof.

Clause 11: A system for providing a merchant-based social network for at least one merchant, the system comprising: at least one processor programmed or configured to: determine to grant access to a group merchant network for a first merchant based on qualification data associated with the group merchant network; determine identification data associated with an identifier of at least one second merchant of the group merchant network based on at least one merchant alignment parameter; communicate the identification data associated with the identifier of each merchant of a plurality of merchants of the group merchant network based on determining the identification data associated with the identifier of at least one second merchant; receive a selection of at least one second merchant of the plurality of merchants of the group merchant network; communicate an invitation request message based on receiving the selection of the at least one second merchant, wherein the invitation request message comprises an invitation for the at least one second merchant to join an individual merchant network associated with the first merchant; receive an invitation response message after communicating the invitation request message, wherein the invitation response message comprises an indication that indicates whether the at least one second merchant will join the individual merchant network associated with the first merchant; grant access to the individual merchant network associated with the first merchant for the at least one second merchant based on the invitation response message; and wherein, based on granting access to the individual merchant network associated with the first merchant, the at least one processor programmed or configured to: authorize the at least one second merchant to cause a transaction offset associated with the first merchant to be generated, and authorize the first merchant to cause a transaction offset associated with the at least one second merchant to be generated.

Clause 12: The system of clause 11, wherein the at least one processor is programmed or configured to: communicate a notification message to the first merchant based on determining to provide access to the group merchant network for the first merchant, wherein the notification message comprises at least one of: group merchant network data associated with the first merchant, merchant location restriction data associated with the first merchant, merchant participation restriction data associated with the first merchant, or any combination thereof.

Clause 13: The system of clauses 11 or 12, wherein the at least one processor, when receiving the selection of the at least one second merchant, is programmed or configured to: receive the selection of the at least one second merchant after communicating the identification data associated with the identifier of at least one second merchant.

Clause 14: The system of any of clauses 11-13, wherein the at least one processor is programmed or configured to: determine whether to generate a transaction offset based at least partially on transaction data associated with a payment transaction and at least one merchant redemption rule; generate the transaction offset based on determining to generate the transaction offset, wherein the transaction offset comprises transaction offset application parameters.

Clause 15: The system of any of clauses 11-14, wherein the at least one processor is programmed or configured to: determine whether to generate a transaction offset based at least partially on transaction data associated with a payment transaction and at least one merchant redemption rule; generate the transaction offset based on determining to generate the transaction offset, wherein the transaction offset comprises transaction offset application parameters.

Clause 16: A computer program product for providing a merchant-based social network for at least one merchant, comprising at least one non-transitory computer-readable medium including one or more instructions that, when executed by at least one processor, cause the at least one processor to: determine whether to grant access to the group merchant network for a first merchant based on qualification data associated with the group merchant network; determine identification data associated with an identifier of at least one second merchant of the group merchant network based on at least one merchant alignment parameter; communicate the identification data associated with the identifier of at least one second merchant based on determining the identification data associated with the identifier of at least one second merchant; receive a selection of the at least one second merchant; communicate an invitation request message based on receiving the selection of the at least one second merchant, wherein the invitation request message comprises an invitation for the at least one second merchant to join an individual merchant network associated with the first merchant; receive an invitation response message after communicating the invitation request message, wherein the invitation response message comprises an indication that indicates whether the at least one second merchant will join the individual merchant network associated with the first merchant; grant access to the individual merchant network associated with the first merchant for the at least one second merchant based on the invitation response message; and wherein, based on granting access to the individual merchant network associated with the first merchant, the one or more instructions further cause the at least one processor to authorize the at least one second merchant to cause a transaction offset associated with the first merchant to be generated, and authorize the first merchant to cause a transaction offset associated with the at least one second merchant to be generated.

Clause 17: The computer program product of clause 16, wherein the one or more instructions further cause the at least one processor to: determine to generate a transaction offset based at least partially on transaction data associated with a payment transaction and at least one merchant redemption rule; generate the transaction offset based on determining to generate the transaction offset, wherein the transaction offset comprises transaction offset application parameters.

Clause 18: The computer program product of clauses 16 or 17, wherein the at least one merchant redemption rule comprises merchant redemption rule criteria, wherein the merchant redemption rule criteria comprises at least one of: a threshold value associated with a transaction amount of a payment transaction, a threshold value associated with a time of a payment transaction, a threshold value of a number of payment transactions involving a customer and the first merchant, group merchant network data associated with the at least one second merchant, or any combination thereof.

Clause 19: The computer program product of any of clauses 16-18, wherein the one or more instructions further cause the at least one processor to: receive authorization data from the first merchant, wherein the authorization data comprises an indication that the first merchant authorizes the at least one second merchant to generate a transaction offset associated with the first merchant based on transaction offset data associated with the transaction offset from the at least one second merchant; and generate the transaction offset based on receiving the authorization data from the first merchant.

Clause 20: The computer program product of any of clauses 16-19, wherein the one or more instructions further cause the at least one processor to: receive authorization data from the at least one second merchant, wherein the authorization data comprises an indication that the at least one second merchant authorizes the first merchant to generate a transaction offset associated with the at least one second merchant based on transaction offset data associated with the transaction offset from the first merchant; and generate the transaction offset based on receiving the authorization data from the at least one second merchant.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a diagram of a non-limiting embodiment of an environment in which systems, devices, products, apparatus, and/or methods, described herein, may be implemented according to the principles of the present invention;

FIG. 2 is a diagram of a non-limiting embodiment of components of one or more devices of FIG. 1;

FIG. 3 is a flowchart of a non-limiting embodiment of a process for providing a merchant-based social network for at least one merchant according to the principles of the present invention; and

FIGS. 4A-4D are diagrams of an implementation of a non-limiting embodiment of the process shown in FIG. 3.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet and/or the like) that includes data. It will be appreciated that numerous other arrangements are possible. It will be appreciated that numerous other arrangements are possible.

As used herein, the terms “issuer institution,” “portable financial device issuer,” “issuer,” or “issuer bank” may refer to one or more entities that provide one or more accounts to a user (e.g., customer, consumer, and/or the like) for conducting transactions (e.g., payment transactions), such as initiating credit and/or debit payments. For example, an issuer institution may provide an account identifier, such as a personal account number (PAN), to a user that uniquely identifies one or more accounts associated with that user. The account identifier may be embodied on a portable financial device, such as a physical financial instrument (e.g., a payment card), and/or may be electronic and used for electronic payments. In some non-limiting embodiments, an issuer institution may be associated with a bank identification number (BIN) that uniquely identifies the issuer institution. As used herein “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “account identifier” may refer to one or more types of identifiers associated with a user account (e.g., an account identifier, a PAN, a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payments. In some non-limiting embodiments, the account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of identifier. Account identifiers may be alphanumeric, any combination of characters and/or symbols, and/or the like.

As used herein, the term “token” may refer to an identifier that is used as a substitute or replacement identifier for an account identifier, such as a PAN. A token may be used as a substitute or replacement identifier for an original account identifier, such as a PAN. Tokens may be associated with a PAN or other original account identifier in one or more data structures (e.g., one or more databases and/or the like) such that they may be used to conduct a transaction without directly using the original account identifier. In some non-limiting embodiments, an original account identifier, such as a PAN, may be associated with a plurality of tokens for different individuals or purposes. In some non-limiting embodiments, tokens may be associated with a PAN or other account identifiers in one or more data structures such that they can be used to conduct a transaction without directly using the account identifier, such as a PAN. In some examples, an account identifier, such as a PAN, may be associated with a plurality of tokens for different uses or different purposes.

As used herein, the term “merchant” may refer to one or more entities (e.g., operators of retail businesses) that provide goods and/or services, and/or access to goods and/or services, to a user based on a transaction, such as a payment transaction. As used herein “merchant system” may refer to one or more computer systems operated by or on behalf of a merchant, such as a server executing one or more software applications. As used herein, the term “product” may refer to one or more goods and/or services offered by a merchant.

As used herein, a “point-of-sale (POS) device” may refer to one or more devices, which may be used by a merchant to conduct a transaction (e.g., a payment transaction) and/or process a transaction. For example, a POS device may include one or more computers, peripheral devices, card readers, near-field communication (NFC) receivers, radio frequency identification (RFID) receivers, and/or other contactless transceivers or receivers, contact-based receivers, payment terminals, computers, servers, input devices, and/or the like.

As used herein, a “POS system” may refer to one or more computers and/or peripheral devices used by a merchant to conduct a transaction. For example, a POS system may include one or more POS devices, and/or other like devices that may be used to conduct a payment transaction. A POS system (e.g., a merchant POS system) may also include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein “transaction service provider system” may refer to one or more computer systems operated by or on behalf of a transaction service provider, such as a transaction service provider system executing one or more software applications. A transaction service provider system may include one or more processors and, in some non-limiting embodiments, may be operated by or on behalf of a transaction service provider.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet application, a personal digital assistant (PDA), a pager, a security card, a computer, an access card, a wireless terminal, and/or a transponder, as examples. The portable financial device may include volatile or non-volatile memory to store information (e.g., an account identifier, a name of the account holder, and/or the like).

As used herein, the terms “client” and “client device” may refer to one or more client-side devices or systems, remote from a transaction service provider, used to initiate or facilitate a transaction. As an example, a “client device” may refer to one or more POS devices and/or POS systems used by a merchant. It will be appreciated that a client device may be any electronic device configured to communicate with one or more networks and initiate or facilitate transactions such as, but not limited to, one or more computers, portable computers, tablet computers, cellular phones, wearable devices (e.g., watches, glasses, lenses, clothing, and/or the like), PDAs, and/or other like devices. Moreover, a “client” may also refer to an entity, such as a merchant, that owns, utilizes, and/or operates a client device for initiating transactions with a transaction service provider.

As used herein, the term “server” may refer to one or more computing devices, such as processors, storage devices, and/or similar computer components that communicate with client devices and/or other computing devices over a network, such as the Internet or private networks, and, in some examples, facilitate communication among other servers and/or client devices. It will be appreciated that various other arrangements are possible. As used herein, the term “system” may refer to one or more computing devices or combinations of computing devices, such as but not limited to processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments of the present invention are directed to systems, methods, and computer program products for providing a merchant-based social network for at least one merchant. Non-limiting embodiments of the invention allow for a merchant to join a group merchant network of merchants independent of non-merchants (e.g., the group merchant network includes only merchants). In this way, other merchants that are of interest to the merchant may be determined based on the group merchant network. Accordingly, processor and network resources may be reduced when compared to the merchant manually searching for information associated with other merchants and attempting to determine other merchants that are of interest to the merchant. Additionally, the accuracy of determining other merchants that are of interest to the merchant may be improved.

Non-limiting embodiments of the invention allow for other merchants to join an individual merchant network of the merchant and allow for the merchant to generate transaction offsets (e.g., rewards, and/or the like) associated with the other merchants or vice versa to customers in order to cause the customers to conduct business with the merchant. In this way, the merchant may identify some or all of the goods and services offered by the other merchants. Additionally or alternatively, the merchant may communicate transaction offsets associated with other merchants to customers that are more appealing to the customers than transaction offsets that are not associated with other merchants.

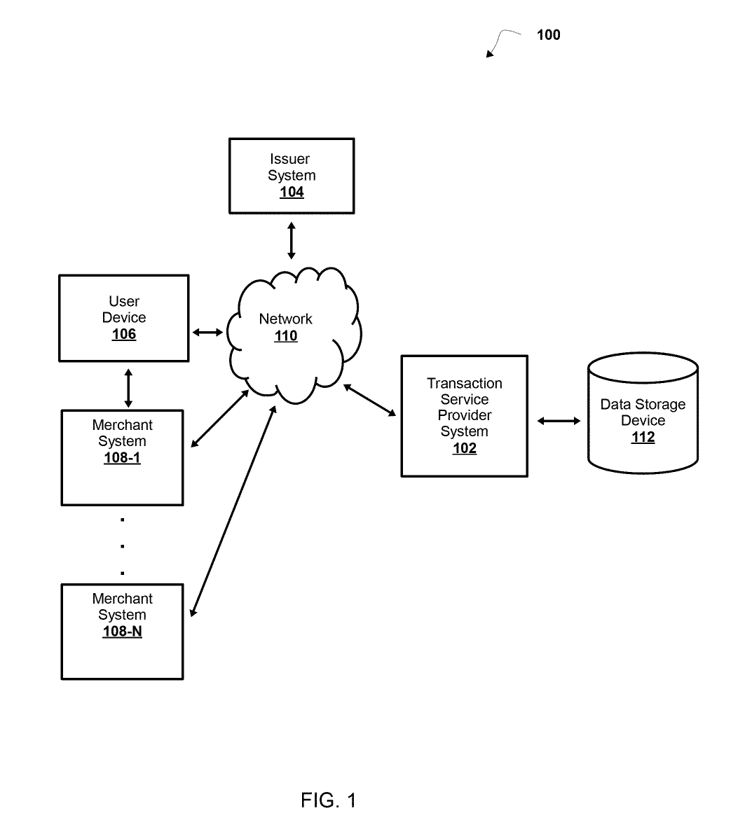

Referring now to FIG. 1, FIG. 1 is a diagram of an example environment 100 in which devices, systems, and/or methods, described herein, may be implemented. As shown in FIG. 1, environment 100 includes a transaction service provider system 102, an issuer system 104, a user device 106, one or more merchant systems 108-1 through 108-N (N≥1) (hereinafter referred to collectively as “merchant systems 108” and individually as “merchant system 108”), and a network 110. As discussed herein, a first merchant may refer to a merchant associated with merchant system 108-1 and a second merchant may refer to a merchant that is a member of a group merchant network and that is associated with merchant system 108-N.

Transaction service provider system 102 may include one or more devices capable of receiving information from issuer system 104, user device 106, and/or merchant system 108 via network 110 and/or communicating information to issuer system 104, user device 106, and/or merchant system 108 via network 110. For example, transaction service provider system 102 may include a computing device, such as a server (e.g., a transaction processing server), a group of servers, and/or other like devices. In some non-limiting embodiments, transaction service provider system 102 may be associated with transaction service provider as described herein. In some non-limiting embodiments, transaction service provider system 102 may be in communication with a data storage device 112, which may be local or remote to the transaction service provider system 102. In some non-limiting embodiments, transaction service provider system 102 may be capable of receiving information from, storing information in, communicating information to, or searching information stored in data storage device 112.

Issuer system 104 may include one or more devices capable of receiving information from transaction service provider system 102 and/or user device 106 via a network (e.g., network 110) and/or communicating information to transaction service provider system 102 and/or user device 106 via the network. For example, issuer system 104 may include a computing device, such as a server, a group of servers, and/or other like devices. In some non-limiting embodiments, issuer system 104 may be associated with an issuer institution as described herein. For example, issuer system 104 may be associated with an issuer institution that issued a credit account, debit account, credit card, debit card, and/or the like to a user associated with user device 106.

User device 106 may include one or more devices capable of receiving information from and/or communicating information to transaction service provider system 102, issuer system 104, and/or merchant system 108, via network 110. For example, user device 106 may include a client device and/or the like. In some non-limiting embodiments, user device 106 may or may not be capable of receiving information (e.g., from merchant system 108) via a short range wireless communication connection (e.g., an NFC communication connection, an RFID communication connection, a Bluetooth® communication connection, and/or the like), and/or communicating information (e.g., to merchant system 108) via a short range wireless communication connection.

Merchant system 108 (e.g., merchant system 108-1, merchant system 108-N) may include one or more devices capable of receiving information from transaction service provider system 102, issuer system 104, and/or user device 106 via network 110 and/or communicating information to transaction service provider system 102, issuer system 104, and/or user device 106 via network 110. Merchant system 108 may also include a device capable of receiving information from user device 106 via network 110, a communication connection (e.g., an NFC communication connection, an RFID communication connection, a Bluetooth® communication connection, and/or the like) with user device 106, and/or the like, and/or communicating information to user device 106 via the network, the communication connection, and/or the like. For example, merchant system 108 may include a computing device, such as a server, a group of servers, a client device, a group of client devices, and/or other like devices. In some non-limiting embodiments, merchant system 108 may be associated with a merchant as described herein. In some non-limiting embodiments, merchant system 108 may include one or more user devices 106. For example, merchant system 108 may include user device 106 that allows a merchant to communicate information to transaction service provider system 102. In some non-limiting embodiments, merchant system 108 may include one or more devices, such as computers, computer systems, and/or peripheral devices capable of being used by a merchant to conduct a payment transaction with a user. For example, merchant system 108 may include a POS device and/or a POS system.

Network 110 may include one or more wired and/or wireless networks. For example, network 110 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

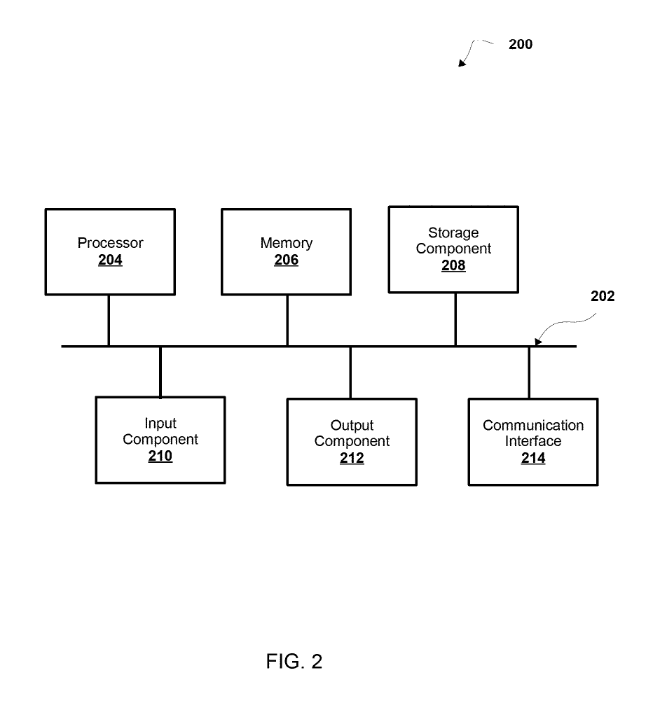

Referring now to FIG. 2, FIG. 2 is a diagram of example components of a device 200. Device 200 may correspond to transaction service provider system 102, and/or one or more devices of issuer system 104, user device 106, and/or merchant system 108 (e.g., merchant system 108-1, merchant system 108-N). In some non-limiting embodiments, transaction service provider system 102, issuer system 104, user device 106, and/or merchant system 108 (e.g., merchant system 108-1, merchant system 108-N) may include at least one device 200 and/or at least one component of device 200. As shown in FIG. 2, device 200 may include a bus 202, a processor 204, memory 206, a storage component 208, an input component 210, an output component 212, and a communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include a random access memory (RAM), a read only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

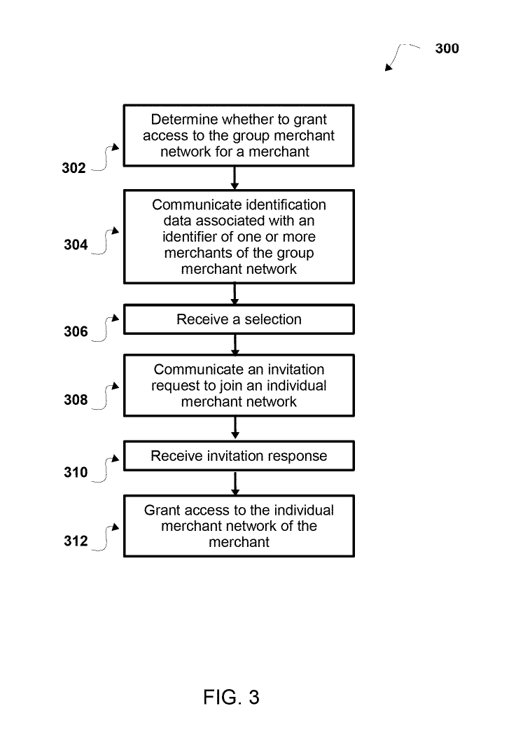

Referring now to FIG. 3, FIG. 3 is a flowchart of a non-limiting embodiment of a process 300 for providing a merchant-based social network for at least one merchant. In some non-limiting embodiments, one or more of the steps of process 300 may be performed (e.g., completely, partially, etc.) by transaction service provider system 102 (e.g., one or more devices of transaction service provider system 102). In some non-limiting embodiments, one or more of the steps of process 300 may be performed (e.g., completely, partially, etc.) by another device or a group of devices separate from or including transaction service provider system 102, such as issuer system 104 (e.g., one or more devices of issuer system 104), user device 106, or merchant system 108 (e.g., one or more devices of merchant system 108).

As shown in FIG. 3, at step 302, process 300 includes determining whether to grant access to the group merchant network. For example, transaction service provider system 102 may determine (e.g., automatically) whether to provide access to the group merchant network for a merchant (e.g., the first merchant associated with merchant system 108-1, a merchant that is not part of the group merchant network, and/or the like). In some non-limiting embodiments, transaction service provider system 102 may determine whether to provide access to the group merchant network for the first merchant based on qualification data. For example, transaction service provider system 102 may determine to grant access or not to grant access for the first merchant based on determining that the qualification data for the first merchant satisfies qualification criteria.

In some non-limiting embodiments, the qualification data may include an indication (e.g., data associated with a merchant system, data associated with merchant system 108, and/or the like) that the merchant is associated with a merchant system (e.g., merchant system 108-1). For example, the qualification data may include a device identifier of a POS device of merchant system 108-1. In some non-limiting embodiments, the qualification data may include transaction data associated with payment transactions involving the first merchant. For example, the qualification data may include transaction data associated with past (e.g., historical) payment transactions involving the first merchant, such as an average transaction amount of past payment transactions involving the first merchant, a number of past payment transactions involving the merchant during a predetermined time interval, and/or the like. In some non-limiting embodiments, the qualification data may include location data associated with a location of the first merchant, such as a value of a distance of the first merchant from other merchants.

In some non-limiting embodiments, the qualification criteria may include criteria that may be compared to the qualification data to determine whether to grant access to the group merchant network. For example, the group merchant qualification criteria may include an indication that the first merchant is associated with a predetermined merchant system (e.g., merchant system 108-1, and/or the like). For example, the qualification criteria may include a predetermined device identifier of a POS device of merchant system 108-1. In some non-limiting embodiments, the qualification criteria may include predetermined transaction data associated with payment transactions involving the first merchant. For example, the qualification criteria may include predetermined transaction data associated with past payment transactions involving the first merchant, such as a threshold of an average transaction amount of past payment transactions involving the first merchant, a threshold number of past payment transactions involving the first merchant during a predetermined time interval, and/or the like. In some non-limiting embodiments, the qualification criteria may include predetermined location data associated with a location of the first merchant, such as a threshold value of a distance of the first merchant from other merchants (e.g., merchants that are part of the group merchant network).

In some non-limiting embodiments, transaction service provider system 102 may compare qualification data for a merchant to determine whether the qualification data satisfies qualification criteria. Transaction service provider system 102 may grant access or not to grant access to the group merchant network for the merchant based on determining that the qualification data for the merchant satisfies the qualification criteria. For example, transaction service provider system 102 may grant access for the first merchant based on determining that the qualification data for the first merchant satisfies the qualification criteria. In such an example, transaction service provider system 102 may not grant access for the first merchant based on determining that the qualification data for the first merchant does not satisfy the qualification criteria.

In some non-limiting embodiments, transaction service provider system 102 may determine (e.g., automatically) qualification data and/or qualification criteria. For example, transaction service provider system 102 may determine qualification data associated with a group merchant network for the first merchant based on receiving an access request (e.g., an access request message) from merchant system 108-1 (e.g., a user device associated with merchant system 108-1, and/or the like) associated with the first merchant. In some non-limiting embodiments, transaction service provider system 102 may determine the qualification data and/or qualification criteria based on the access request. For example, transaction service provider system 102 may determine the qualification data and/or qualification criteria based on identification data (e.g., identification data associated with an identifier of the first merchant, an identifier, a merchant identifier of the first merchant, the first merchant's user name, the first merchant's user handle, a subscription identifier of the first merchant, and/or the like) included in the access request.

In some non-limiting embodiments, a group merchant network may include a social network of a plurality of merchants (e.g., merchants associated with merchant systems 108) independent of non-merchants (e.g., independent of users, independent of consumers, independent of customers, independent of issuer institutions, independent of transaction service providers, and/or the like) that is operated by transaction service provider system 102. For example, the group merchant network may include a social network that includes only merchants associated with merchant systems 108 as part of (e.g., as members of) the social network. In some non-limiting embodiments, each merchant of the group merchant network may communicate with other merchants of the group merchant network by communicating via transaction service provider system 102 and/or a communication connection between the merchant systems. For example, a merchant system associated with a merchant (e.g., merchant system 108-N associated with the second merchant) of the group merchant network may communicate a message to transaction service provider system 102 and transaction service provider system 102 may communicate the message to another merchant system associated with another merchant (e.g., another merchant system 108 associated with another merchant) of the group merchant network. Additionally or alternatively, a merchant system associated with a merchant of the group merchant network may communicate a message to another merchant system associated with another merchant of the group merchant network.

In some non-limiting embodiments, each merchant that is a member of the group merchant network may be able to join an individual merchant network associated with another merchant of the group merchant network. For example, the second merchant may be able to join an individual merchant network of another merchant (e.g., another merchant associated with another merchant system 108) based on the second merchant granting access for the other merchant to the individual network of the second merchant. In some non-limiting embodiments, transaction service provider system 102 may store merchant profiles of each merchant of the group merchant network in data storage device 112. For example, transaction service provider system 102 may store the merchant profiles of each merchant of the group merchant network in a data structure associated with data storage device 112.

In some non-limiting embodiments, an individual merchant network may include a social network, independent of non-merchants, of a merchant (e.g., the second merchant, the first merchant after the first merchant is granted access to the group merchant network) that is member of a group merchant network and at least one other merchant (e.g., another merchant associated with a merchant system 108) of the group merchant network. The individual merchant network may be operated by transaction service provider system 102. In some non-limiting embodiments, each merchant of the individual merchant network may communicate with other merchants of the individual merchant network by communicating via transaction service provider system 102 and/or a communication connection between merchant systems. For example, a merchant system associated with a merchant (e.g., merchant system 108-N associated with the second merchant) of the individual merchant network may communicate a message to transaction service provider system 102 and transaction service provider system 102 may communicate the message to another merchant system associated with another merchant (e.g., merchant system 108 associated with another merchant) of the individual merchant network. Additionally or alternatively, a merchant system associated with a merchant of the individual merchant network may communicate a message to another merchant system associated with another merchant of the individual merchant network.

In some non-limiting embodiments, an access request may include a request from the first merchant to join the group merchant network operated by transaction service provider system 102. In some non-limiting embodiments, transaction service provider system 102 may receive the access request from merchant system 108-1 associated with the first merchant before or after determining qualification data for the first merchant. For example, transaction service provider system 102 may receive transaction data from merchant system 108-1, where the transaction data is associated with a payment transaction involving the first merchant and a user (e.g., a customer, a consumer, and/or the like). Transaction service provider system 102 may determine the qualification data associated with the group merchant network for the first merchant involved in the payment transaction based on the transaction data associated with the payment transaction.

In some non-limiting embodiments, transaction service provider system 102 may compare the qualification data to group merchant network qualification criteria based on determining the group merchant network qualification data. Transaction service provider system 102 may determine whether the group merchant network qualification data corresponds to group merchant network qualification criteria and may determine to grant access to the group merchant network for the first merchant based on determining that the group merchant network qualification data corresponds to group merchant network qualification criteria.

In some non-limiting embodiments, transaction service provider system 102 may communicate an offer (e.g., an offer message). For example, transaction service provider system 102 may communicate the offer (e.g., that includes an offer to join the group merchant network) to merchant system 108-1 after comparing qualification data for the first merchant to qualification criteria and/or after determining that the qualification data satisfies the qualification criteria. In some non-limiting embodiments, transaction service provider system 102 may receive the access request from merchant system 108-1 after communicating the offer to merchant system 108-1. In such an example, merchant system 108-1 may communicate the access request after receiving the offer and transaction service provider system 102 may receive the access request from merchant system 108-1. In some non-limiting embodiments, transaction service provider system 102 may determine the qualification data for the first merchant based on receiving the access request from merchant system 108-1.

In some non-limiting embodiments, transaction service provider system 102 may receive an offer response (e.g., an offer response message) from a merchant system (e.g., merchant system 108-1) that includes an indication that a merchant (e.g., the first merchant) associated with the merchant system will join the group merchant network. For example, transaction service provider system 102 may receive an offer response (e.g., that includes a response to an offer to join the group merchant network) from merchant system 108-1 that includes the access request from the first merchant. In some non-limiting embodiments, transaction service provider system 102 may receive an offer response that includes an indication that the first merchant declines to join the group merchant network.

In some non-limiting embodiments, transaction service provider system 102 may determine group merchant network data, merchant location restriction data, and/or merchant participation restriction data associated with a merchant (e.g., the first merchant, the second merchant, and/or the like) based on granting access to the group merchant network for the merchant. For example, transaction service provider system 102 may determine group merchant network data, merchant location restriction data, and/or merchant participation restriction data for the first merchant based on granting access to the group merchant network for the first merchant after receiving an indication that the first merchant accepts the offer to join the group merchant network. In some non-limiting embodiments, transaction service provider system 102 may determine the group merchant network data, the merchant location restriction data, and/or the merchant participation restriction data for the first merchant based on receiving the access request from merchant system 108-1.

In some non-limiting embodiments, the group merchant network data may include merchant category data (e.g., a merchant category code, and/or the like) associated with one or more merchant categories of a merchant, transaction amount data (e.g., an average transaction amount, an average transaction volume, and/or the like) associated with a transaction amount of one or more payment transactions involving a merchant, transaction time data (e.g., time periods of payment transactions, and/or the like) associated with a time of one or more payment transactions involving a merchant, merchant alignment parameter data associated with one or more merchant alignment parameters, and/or the like. In some non-limiting embodiments, the merchant location restriction data may include location data associated with a location of a merchant, such as boundary data associated with a boundary of a location of a merchant (e.g., a country, a state, a zip code, a county, a municipality, and/or the like), distance data (e.g., a predetermined linear distance, a predetermined distance based on roadways, and/or the like) associated with a distance of a location of the merchant from one or more locations of other merchants, and/or the like. In some non-limiting embodiments, the merchant participation restriction data may include a transaction offset application parameter of a transaction offset associated with a merchant, time interval data associated with a time interval to apply a transaction offset, time interval data associated with a time interval to generate a transaction offset, a number of merchants that may join an individual merchant network of a merchant, and/or the like. In some non-limiting embodiments, transaction service provider system 102 may receive the qualification data, group merchant network data, merchant location restriction data, and/or merchant participation restriction data from a merchant system (e.g., merchant system 108-1 and/or merchant system 108-N).

In some non-limiting embodiments, transaction service provider system 102 may store the qualification data, group merchant network data, merchant location restriction data, and/or merchant participation restriction data in a merchant profile (e.g., a merchant profile associated with a merchant, such as the first merchant, the second merchant, and/or the like). For example, transaction service provider system 102 may store the group merchant network data, merchant location restriction data, and/or merchant participation restriction data for the first merchant in the merchant profile for the first merchant based on receiving the qualification data, group merchant network data, merchant location restriction data, and/or merchant participation restriction data from merchant system 108-1.

In some non-limiting embodiments, transaction service provider system 102 may communicate a notification message to merchant system 108-1 based on granting access to the group merchant network for the first merchant. For example, transaction service provider system 102 may communicate the notification message to merchant system 108-1, where the notification message includes the qualification data, the group merchant network data, the merchant location restriction data, and/or the merchant participation restriction data for the first merchant, based on granting access to the group merchant network for the first merchant. Additionally or alternatively, the notification message may include an indication that the first merchant has been granted access to the group merchant network.

As further shown in FIG. 3, at step 304, process 300 includes communicating identification data associated with an identifier of one or more merchants of the group merchant network. For example, transaction service provider system 102 may communicate the identification data associated with an identifier of one or more merchants (e.g., the second merchant of the group merchant network, a plurality of merchants of the group merchant network, all of the merchants of the group merchant network, and/or the like) of the group merchant network to merchant system 108-1.

In some non-limiting embodiments, transaction service provider system 102 may determine (e.g., automatically) the one or more merchants of the group merchant network that are of interest to the first merchant. For example, transaction service provider system 102 may determine a plurality of merchants of the group merchant network based on data associated with the plurality of merchants that corresponds to a merchant alignment parameter (e.g., a parameter associated with a predetermined merchant category code, a parameter associated with a merchant that is within a predetermined distance of a location, such as the location of the first merchant, a parameter associated with conducting payment transactions in a predetermined payment channel, such as a payment transaction conducted with a POS device in a merchant location, an online payment transaction conducted with a POS system, and/or the like). Additionally or alternatively, transaction service provider system 102 may determine a plurality of merchants of the group merchant network based on transaction data associated with one or more payment transaction involving a user that has conducted one or more payment transactions with one or more of the plurality of merchants and the first merchant. For example, transaction service provider system 102 may determine a plurality of merchants of the group merchant network based on a PAN of the user, a billing amount associated with the PAN of the user, a time of a payment transaction involving the user, a billing conversion rate associated with the user, a merchant category code associated with one or more of the plurality of merchants and/or the first merchant, an acquirer country code associated with an acquirer, a country code associated with a PAN of the user, a response code associated with the one or more payment transactions, identification data associated with an identity of a card acceptor, and/or a country code associated with the user.

In some non-limiting embodiments, transaction service provider system 102 may determine a ranking of each of the plurality of merchants of the group merchant network that are of interest to the first merchant. For example, transaction service provider system 102 may determine a list of each of the plurality of merchants of the group merchant network that ranked based on an interest of each of the plurality of merchants to the first merchant. In some non-limiting embodiments, transaction service provider system 102 may communicate data associated with the ranking to the first merchant based on determining the ranking.

In some non-limiting embodiments, transaction service provider system 102 may determine one or more merchants (e.g., the second merchant of the group merchant network, a plurality of merchants of the group merchant network, all of the merchants of the group merchant network, and/or the like) of the group merchant network that is of interest to the first merchant based on that group merchant network data, merchant location restriction data, and/or merchant participation restriction data of the one or more merchants of the group merchant network. For example, transaction service provider system 102 may determine that the group merchant network data, the merchant location restriction data, and/or the merchant participation restriction data of the second merchant corresponds to the merchant alignment parameter.

In some non-limiting embodiments, transaction service provider system 102 may determine group merchant network data associated with the one or more merchants of the group merchant network based on a merchant profile for the second merchant stored in data storage device 112. Transaction service provider system 102 may compare the group merchant network data to one or more merchant alignment parameters and determine whether the group merchant network data corresponds to the one or more merchant alignment parameters. In some non-limiting embodiments, transaction service provider system 102 may communicate the identification data associated with an identifier of the one or more merchants of the group merchant network based on determining that the group merchant network data associated with the one or more merchants of the group merchant network corresponds to the one or more merchant alignment parameters.

In some non-limiting embodiments, transaction service provider system 102 may determine whether one or more merchants (e.g., the second merchant of the group merchant network, a plurality of merchants of the group merchant network, all of the merchants of the group merchant network, and/or the like) of the group merchant network is willing to join an individual merchant network of the first merchant before communicating identification data associated with an identifier of the one or more merchants of the group merchant network. For example, transaction service provider system 102 may determine that the merchant profile of the one or more merchants of the group merchant network includes an indication that the one or more merchants of the group merchant network is willing to join an individual merchant network of the first merchant. Transaction service provider system 102 may communicate the identification data associated with the identifier of the one or more merchants of the group merchant network to merchant system 108-1 based on determining that the merchant profile associated with the one or more merchants of the group merchant network merchant includes an indication that the one or more merchants is willing to join the individual merchant network. In some non-limiting embodiments, transaction service provider system 102 may communicate a notification (e.g., a notification message) to merchant system 108-1 based on determining that the merchant profile associated with the one or more merchants of the group merchant network includes an indication that the one or more merchants of the group merchant network is not willing to join an individual merchant network of the first merchant. For example, transaction service provider system 102 may communicate a notification message to merchant system 108-1 that includes an indication that the one or more merchants of the group merchant network is not willing to join the individual merchant network of the first merchant.

In some non-limiting embodiments, transaction service provider system 102 may receive one or more merchant alignment parameters from the first merchant and/or the second merchant. For example, transaction service provider system 102 may receive one or more merchant alignment parameters from the first merchant after granting access to the group merchant network for the first merchant. In another example, the one or more merchant alignment parameters may be included in an access request received from the first merchant. Transaction service provider system 102 may determine the one or more merchant alignment parameters from the access request based on receiving the access request from the first merchant.

In some non-limiting embodiments, transaction service provider system 102 may receive a search request (e.g., a search request message) from a merchant system (e.g., merchant system 108-1). For example, transaction service provider system 102 may receive the search request from merchant system 108-1 after transaction service provider system 102 grants access to the group merchant network for the first merchant. In some non-limiting embodiments, the search request may include one or more merchant alignment parameters. In some non-limiting embodiments, transaction service provider system 102 may determine the identification data associated with the identifier of one or more merchants (e.g., the second merchant of the group merchant network, a plurality of merchants of the group merchant network, all of the merchants of the group merchant network, and/or the like) of the group merchant network based on receiving the search request. For example, transaction service provider system 102 may determine one or more merchant alignment parameters included in the search request based on receiving the search request from merchant system 108-1. Transaction service provider system 102 may compare the one or more merchant alignment parameters to group merchant network data for one or more merchants (e.g., the second merchant of the group merchant network, a plurality of merchants of the group merchant network, all of the merchants of the group merchant network, and/or the like) of the group merchant network. Transaction service provider system 102 may determine that the group network data for the one or more merchants of the group merchant network corresponds to the one or more merchant alignment parameters and transaction service provider system 102 may determine identification data associated with the identifier of the one or more merchants based on determining that the group network data for the one or more merchants corresponds to the one or more merchant alignment parameters. In some non-limiting embodiments, transaction service provider system 102 may determine the identification data associated with the identifier of one or more merchants of the group merchant network based on one or more merchant alignment parameters and/or qualification data associated with the first merchant.

In some non-limiting embodiments, transaction service provider system 102 may determine group merchant network data associated with the second merchant, merchant location restriction data associated with the second merchant, and/or merchant participation restriction data associated with the second merchant. For example, transaction service provider system 102 may determine the group merchant network data associated with the at least one second merchant, the merchant location restriction data associated with the at least one second merchant, and/or the merchant participation restriction data associated with the at least one second merchant. In some non-limiting embodiments, transaction service provider system 102 may communicate group merchant network data associated with the second merchant, merchant location restriction data associated with the second merchant, and/or merchant participation restriction data associated with the second merchant. For example, transaction service provider system 102 may communicate group merchant network data associated with the second merchant, merchant location restriction data associated with the second merchant, and/or merchant participation restriction data associated with the second merchant based on determining the group merchant network data associated with the second merchant, the merchant location restriction data associated with the second merchant, and/or the merchant participation restriction data associated with the second merchant.

As further shown in FIG. 3, at step 306, process 300 includes receiving a selection of one or more merchants of the group merchant network. For example, transaction service provider system 102 may receive a selection (e.g., a selection message) of one or more merchants (e.g., the second merchant of the group merchant network, a plurality of merchants of the group merchant network, all of the merchants of the group merchant network, and/or the like) of the group merchant network from merchant system 108-1. In some non-limiting embodiments, the selection of the one or more merchants of the group of merchants includes an indication that the first merchant invites the one or more merchants of the group merchant network to join an individual merchant network of the first merchant. In some non-limiting embodiments, transaction service provider system 102 may receive the selection of the one or more merchants of the group merchant network from merchant system 108-1 after communicating identification data associated with an identifier of the one or more merchants.

In some non-limiting embodiments, transaction service provider system 102 may receive a selection of the identification data associated with the identifier of the one or more merchants of the group merchant network from merchant system 108-1. For example, merchant system 108-1 may communicate the selection of the identification data associated with the identifier of the second merchant and transaction service provider system 102 may receive the selection from merchant system 108-1.

As further shown in FIG. 3, at step 308, process 300 includes communicating an invitation request (e.g., an invitation request message) to the one or more merchants of the group merchant network. For example, transaction service provider system 102 may communicate an invitation request (e.g., that includes an invitation to join an individual merchant network) to merchant system 108-N for the one or more merchants to join an individual merchant network of the first merchant. In some non-limiting embodiments, transaction service provider system 102 may communicate the invitation request based on receiving the selection of the one or more merchants of the group merchant network from merchant system 108-1. For example, transaction service provider system 102 may communicate the invitation request to merchant system 108-N associated with the second merchant based on receiving the selection of the second merchant (e.g., the selection of identification data associated with the second merchant) from merchant system 108-1. In some non-limiting embodiments, the invitation request may include a request from the first merchant to the one or more merchants of the group merchant network for the one or more merchants to join the individual merchant network of the first merchant.

As further shown in FIG. 3, at step 310, process 300 includes receiving an invitation response (e.g., an invitation response message) from the one or more merchants of the group merchant network. For example, transaction service provider system 102 may receive an invitation response from merchant system 108-N after communicating the invitation request to merchant system 108-N. In some non-limiting embodiments, the invitation response may include an indication that the one or more merchants of the group merchant network will join or will not join the individual merchant network of the first merchant that communicated the selection of the one or more merchants to transaction service provider system 102.

In some non-limiting embodiments, transaction service provider system 102 may communicate a notification (e.g., a notification message) to merchant system 108-1 based on receiving the invitation response from the one or more merchants of the group merchant network. For example, transaction service provider system 102 may receive the invitation response from the one or more merchants of the group merchant network. Transaction service provider system 102 may communicate a notification to merchant system 108-1 that includes an indication that the one or more merchants of the group merchant network will join or will not join the individual merchant network of the first merchant based on receiving the invitation response.

As further shown in FIG. 3, at step 312, process 300 includes granting access to the individual merchant network for the one or more merchants of the group merchant network. For example, transaction service provider system 102 may grant access to the individual merchant network of the first merchant for the second merchant. In some non-limiting embodiments, by granting access to the individual merchant network of the first merchant, transaction service provider system 102 may authorize the first merchant to cause a transaction offset regarding the second merchant to be generated and/or the second merchant to cause a transaction offset regarding the first merchant to be generated.

In some non-limiting embodiments, transaction service provider system 102 may receive authorization data from the first merchant, where the authorization data includes an indication that the first merchant authorizes the second merchant to generate a transaction offset associated with the first merchant based on transaction offset data associated with the transaction offset from the second merchant.

In some non-limiting embodiments, a transaction offset may include transaction offset application parameters that are associated with a payment transaction to which the transaction offset is to be applied. In some non-limiting embodiments, the transaction offset application parameters may include a threshold value associated with a transaction amount of a payment transaction (e.g., a threshold transaction amount, a predetermined threshold value of a transaction amount, a predetermined minimum threshold value of a transaction amount, a predetermined maximum threshold value of a transaction amount, and/or the like) to which the transaction offset is to be applied, a threshold value associated with a time of a payment transaction (e.g., a predetermined threshold value of a time of day of a payment transaction (e.g., a time before or after which a transaction may take place for the transaction offset to be applied), a predetermined value of a time range associated with a payment transaction, a predetermined value of a time of day range associated with a payment transaction, a predetermined value of a date range associated with a payment transaction, a predetermined value of a time range from when the transaction offset was generated, and/or the like) to which the transaction offset is to be applied, predetermined data associated with a second merchant (e.g., identification data associated with an identifier of the second merchant, merchant category data associated with a merchant category of the second merchant, and/or the like) that is a member of the individual merchant network of the first merchant involved in the payment transaction, where the second merchant is involved in a payment transaction to which the transaction offset is to be applied, predetermined data associated with a product involved in a payment transaction to which the transaction offset is to be applied, predetermined user identification data associated with an identifier of a user involved in a payment transaction to which the transaction offset is to be applied, predetermined identification data associated with an identifier of a merchant involved in a payment transaction to which the transaction offset is to be applied, a predetermined number of times that the transaction offset may be applied to a payment transaction, and/or the like.

In some non-limiting embodiments, transaction service provider system 102 may receive authorization data from the second merchant, wherein the authorization data includes an indication that the at least one second merchant authorizes the first merchant to generate a transaction offset associated with the second merchant based on transaction offset data associated with the transaction offset from the first merchant.

In some non-limiting embodiments, a transaction offset may include a reward from a merchant (e.g., the first merchant, the second merchant, and/or the like) that is provided to a user (e.g., a consumer, a cardholder, etc.) involved in a payment transaction (e.g., a payment transaction associated with a chargeback) with the merchant. In some non-limiting embodiments, a transaction offset application parameter of a transaction offset may include a reward parameter. For example, the reward parameter may include a monetary discount, an allocation of a monetary amount (e.g., a cashback amount, a percentage of a transaction amount of a payment transaction that is refunded to a user involved in the payment transaction, and/or the like), an additional good or service from a merchant, an additional good or service from a different merchant (e.g., an additional merchant associated with the merchant involved in the payment transaction), and/or the like.

In some non-limiting embodiments, the reward parameter may be applied (e.g., by transaction service provider system 102) based on a threshold value associated with a payment transaction (e.g., a predetermined threshold value of a transaction amount, a predetermined minimum threshold value of a transaction amount, a predetermined maximum threshold value of a transaction amount, a predetermined threshold value of a transaction volume, a predetermined minimum threshold value of a transaction volume, a predetermined maximum threshold value of a transaction volume, a predetermined threshold value of a number of payment transactions, a predetermined minimum threshold value of a number of payment transactions, a predetermined maximum threshold value of a number of payment transactions, and/or the like). For example, a transaction offset may allow a user to receive a monetary discount of 5% of a payment transaction, where the payment transaction involves a merchant that is associated with a transaction offset (e.g., a merchant that provided the transaction offset to a user, a merchant that generated the transaction offset, and/or the like) if a transaction amount of the payment transaction exceeds a minimum threshold value of a transaction amount. In some non-limiting embodiments, the reward parameter may be applied based on a threshold value associated with a payment transaction that involves a merchant associated with the transaction offset and/or a payment transaction that involves a merchant associated with the merchant that is associated with the transaction offset. For example, the reward parameter may be applied based on a threshold value associated with a payment transaction that involves a merchant that is associated with the transaction offset and/or a payment transaction that involves a merchant that is part of a group merchant network of the merchant that is associated with the transaction offset or a merchant that is part of an individual merchant network of the merchant that is associated with the transaction offset.

In some non-limiting embodiments, transaction service provider system 102 may receive transaction offset application parameter data associated with a reward parameter. For example, transaction service provider system 102 may receive transaction offset application parameter data associated with a reward parameter from a merchant that includes a predetermined threshold value of transaction data associated with a payment transaction involving another merchant associated with the merchant (e.g., a merchant that is part of the merchant's group merchant network, a merchant that is part of the merchant's individual merchant network, and/or the like). In some non-limiting embodiments, the transaction offset application parameter data associated with the reward parameter may include an indication of a percentage and/or an amount of transaction data associated with one or more payment transactions involving the other merchant that the merchant will account for when determining whether transaction data associated with one or more payment transactions involving a user and the merchant satisfies a threshold value of transaction data of one or more payment transactions such that a transaction offset associated with the reward parameter will be applied. For example, transaction service provider system 102 may receive the transaction offset application parameter data from the merchant, and the transaction offset application parameter data may indicate that a percentage (e.g., 10%, 20%, and/or the like) of a transaction volume associated with one or more payment transactions involving the user and the other merchant may be accounted for when determining whether the transaction volume associated with one or more payment transactions involving the user and the merchant satisfies a threshold value of transaction volume of one or more payment transactions such that the transaction offset associated with the reward parameter will be applied.

In some non-limiting embodiments, the reward parameter may be applied (e.g., by transaction service provider system 102) based on a plurality of threshold values associated with a payment transaction (e.g., a plurality of predetermined threshold values of a transaction amount, a plurality of predetermined minimum threshold values of a transaction amount, a plurality of predetermined maximum threshold values of a transaction amount, a plurality of predetermined threshold values of a transaction volume, a plurality of predetermined minimum threshold values of a transaction volume, a plurality of predetermined maximum threshold values of a transaction volume, a plurality of predetermined threshold values of a number of payment transactions, a plurality of predetermined minimum threshold values of a number of payment transactions, a plurality of predetermined maximum threshold values of a number of payment transactions, and/or the like). For example, a transaction offset may allow a user to receive a monetary discount of 5% of a payment transaction, where the payment transaction involves a merchant associated with the transaction offset, if a transaction amount of the payment transaction exceeds a first minimum threshold value of a transaction amount. In such an example, a transaction offset may allow the user to receive a monetary discount of 6% of the payment transaction if the transaction amount of the payment transaction exceeds a second minimum threshold value of the transaction amount.

In some non-limiting embodiments, the reward parameter may be applied (e.g., by transaction service provider system 102) based on one or more threshold values associated with a payment transaction (e.g., one or more predetermined threshold values of a transaction amount, one or more predetermined minimum threshold values of a transaction amount, one or more predetermined maximum threshold values of a transaction amount, one or more predetermined threshold values of a transaction volume, one or more predetermined minimum threshold values of a transaction volume, one or more predetermined maximum threshold values of a transaction volume, one or more predetermined threshold values of a number of payment transactions, one or more predetermined threshold values of a minimum number of payment transactions, one or more predetermined threshold values of a maximum number of payment transactions, and/or the like) and one or more predetermined time intervals (e.g., one or more days, one or more weeks, one or more months, one or more years, and/or the like). For example, a transaction offset may allow a user to receive an allocation of a monetary amount of 1% of the transaction amount of a payment transaction if the transaction amount of the payment transaction satisfies a predetermined threshold value of a transaction amount of a payment transaction equal to $500, where the payment transaction involves a merchant associated with the transaction offset and the payment transaction is conducted during a predetermined time interval between Sep. 1, 2017 and Sep. 30, 2017. Additionally or alternatively, the transaction offset may allow the user to receive an allocation of a monetary amount of 2% of the transaction amount of a payment transaction if the transaction amount of the payment transaction satisfies a predetermined threshold value of a transaction amount of a payment transaction equal to $800, where the payment transaction involves the merchant that is associated with transaction offset and the payment transaction is conducted during the predetermined time interval.

In another example, a transaction offset may allow a user to receive an allocation of a monetary amount of $5 if the number of payment transactions between a merchant and a user satisfies a predetermined threshold value of a number of payment transactions equal to 5, where the payment transaction involves the merchant that is associated with the transaction offset and the payment transaction is conducted during a predetermined time interval between Sep. 1, 2017 and Sep. 30, 2017.

Additionally or alternatively, the transaction offset may allow a user to receive an allocation of a monetary amount of $10 if the number of payment transactions between the merchant and the user satisfies a predetermined threshold value of a number of payment transactions equal to 10 and the payment transaction is conducted during the predetermined time interval.

In some non-limiting embodiments, transaction service provider system 102 may authorize the first merchant to cause the generation of a transaction offset associated with the second merchant such that transaction service provider system 102 may generate a transaction offset that includes a reward parameter that may be redeemed by a user during a payment transaction with the second merchant after conducting a payment transaction with the first merchant. Additionally or alternatively, transaction service provider system 102 may authorize the second merchant to cause the generation of a transaction offset associated with the first merchant such that transaction service provider system 102 may generate a transaction offset that includes a reward parameter that may be redeemed by a user during a payment transaction with the first merchant after conducting a payment transaction with the second merchant. In some non-limiting embodiments, transaction service provider system 102 may generate a transaction offset that includes the reward parameter based on receiving a request (e.g., a transaction offset generation request message) to generate a transaction offset from merchant system 108-1. Additionally or alternatively, transaction service provider system 102 may generate a transaction offset that includes the reward parameter based on receiving a request to generate a transaction offset from merchant system 108-N.

In some non-limiting embodiments, transaction service provider system 102 may receive a request to generate a transaction offset (e.g., a transaction offset generation request), where the request includes transaction data associated with a payment transaction involving the first merchant or the second merchant. For example, transaction service provider system 102 may receive the request from the first merchant or the second merchant. The transaction service provider system 102 may receive the request from a user device, a client device, a POS device, and/or the like associated with the first merchant or the second merchant. In some non-limiting embodiments, transaction service provider system 102 may communicate data associated with generating a transaction offset (e.g., data indicating that a transaction offset is to be generated or is not to be generated) to merchant system 108-1 and/or merchant system 108-N based on receiving the request to generate the transaction offset.

In some non-limiting embodiments, transaction service provider system 102 may receive a request to generate a transaction offset (e.g., a transaction offset generation request) from merchant system 108-1 after transaction service provider system 102 communicates transaction data associated with a plurality of payment transactions to merchant system 108-1. In some non-limiting embodiments, transaction service provider system 102 may communicate the transaction data associated with the plurality of transactions to merchant system 108-1, and a device of merchant system 108-1 (e.g., a user device of merchant system 108-1, a POS device of merchant system 108-1, and/or the like) may display the transaction data in a user interface (e.g., a graphical user interface, a portal, and/or the like).

In some non-limiting embodiments, transaction service provider system 102 may determine (e.g., automatically) whether to generate a transaction offset based on transaction data associated with a payment transaction. In some non-limiting embodiments, transaction service provider system 102 may determine whether to generate the transaction offset based on receiving the transaction data associated with a payment transaction involving the first merchant.

In some non-limiting embodiments, transaction service provider system 102 may determine whether to generate a transaction offset based on an input received from merchant system 108-1 (e.g., an input received from the first merchant associated with merchant system 108-1). For example, transaction service provider system 102 may determine to generate a transaction offset based on the input, where the input includes an indication to generate the transaction offset. In another example, transaction service provider system 102 may determine not to generate a transaction offset where the input includes an indication not to generate the transaction offset. In some non-limiting embodiments, the input may include a request to generate a transaction offset. In some non-limiting embodiments, the input may include data associated with the transaction offset (e.g., transaction offset application parameters of the transaction offset, reward parameters of the transaction offset, and/or the like). In some non-limiting embodiments, transaction service provider system 102 may validate the input from the first merchant. For example, transaction service provider system 102 may determine that the data associated with the transaction offset is invalid based on the merchant location restriction data and/or the merchant participation restriction data, where the merchant location restriction data and/or the merchant participation restriction data are determined by transaction service provider system 102. In another example, transaction service provider system 102 may determine that the data associated with the transaction offset is valid based on the merchant location restriction data and/or the merchant participation restriction data.

In some non-limiting embodiments, transaction service provider system 102 may generate a transaction offset with transaction offset application parameters received from the first merchant. In some non-limiting embodiments, transaction service provider system 102 may communicate a prompt (e.g., a prompt communicated via a user interface displayed by user device 106 associated with merchant system 108-1) to the first merchant, and transaction service provider system 102 may receive transaction offset application parameters from the first merchant after communicating the prompt.

In some non-limiting embodiments, transaction service provider system 102 may generate a transaction offset with transaction offset application parameters generated (e.g., automatically) based on a merchant redemption rule. For example, transaction service provider system 102 may determine to generate a transaction offset based on the merchant redemption rule, and transaction service provider system 102 may generate the transaction offset with transaction offset application parameters based on merchant redemption rule criteria. In some non-limiting embodiments, transaction service provider system 102 may generate the transaction offset based on determining that transaction offset application parameters of the transaction offset are valid based on the merchant location restriction data and/or the merchant participation restriction data of the first merchant and/or the second merchant.

In some non-limiting embodiments, the merchant redemption rule criteria may include a threshold value associated with a transaction amount of a payment transaction (e.g., a predetermined threshold value associated with a transaction amount, a predetermined minimum threshold value associated with a transaction amount, a predetermined maximum threshold value associated with a transaction amount, and/or the like), where a transaction offset is generated if a transaction amount of a payment transaction satisfies the threshold value associated with the transaction amount, a threshold value associated with a time of a payment transaction (e.g., a predetermined value associated with a time range of a payment transaction, a predetermined value associated with a time of day range of a payment transaction, a predetermined value associated with a date range of a payment transaction, a predetermined value associated with a time range from when the transaction offset was generated, and/or the like), where a transaction offset is generated if transaction time data associated with a time of a payment transaction satisfies the threshold value associated with the time of the transaction, merchant data associated with an additional merchant (e.g., identification data associated with an identifier of one or more merchants of an individual merchant network, merchant category data associated with a merchant category of one or more merchants of an individual merchant network, and/or the like), where a transaction offset is generated if transaction data associated with a payment transaction includes the merchant data associated with the additional merchant, and/or the like.

In some non-limiting embodiments, the transaction offset application parameters may be the same or different than the merchant redemption rule criteria. For example, if the merchant redemption rule criteria includes a threshold value associated with a transaction amount of a payment transaction, then transaction service provider system 102 may generate the transaction offset with transaction offset application parameters that include the threshold value associated with the transaction amount of the payment transaction. Accordingly, the transaction offset may be applied to a payment transaction when a payment transaction amount of the payment transaction satisfies the threshold value associated with the transaction amount of the transaction offset application parameters. In another example, if the merchant redemption rule criteria includes a threshold value associated with a transaction amount of a payment transaction, transaction service provider system 102 may generate the transaction offset with transaction offset application parameters that include a threshold value associated with a time of a payment transaction. Accordingly, the transaction offset may be applied to a payment transaction when a time of the payment transaction satisfies the threshold value associated with the time of the transaction offset application parameters.

In some non-limiting embodiments, transaction service provider system 102 may store data associated with the transaction offset (e.g., transaction offset application parameters of the transaction offset, an identifier of the transaction offset, merchant transaction offset data, such as merchant identification data associated with an identifier of a merchant that generated the transaction offset, merchant category data associated with a merchant that generated the transaction offset, merchant location data associated with a location of a merchant that generated the transaction offset, user transaction offset data, such as user identification data associated with an identifier of a user to which the transaction offset is assigned, user location data associated with a location of a user to which the transaction offset is assigned, and/or the like). For example, transaction service provider system 102 may store the data in a data structure so that the information may be searched and/or may be obtained by transaction service provider system 102, issuer system 104, and/or merchant system 108 (e.g., merchant system 108-1 and/or merchant system 108-N). In some non-limiting embodiments, the data structure may be located within data storage device 112 associated with transaction service provider system 102. The data associated with the transaction offset may be searched and/or obtained based on user data associated with a user involved in a payment transaction, merchant data associated with a merchant involved in a payment transaction, or any combination thereof.

In some non-limiting embodiments, transaction service provider system 102 may communicate (e.g., automatically) data associated with generating the transaction offset (e.g., data associated with an indication that the transaction offset was generated, transaction offset application parameters, and/or the like) based on generating the transaction offset. In some non-limiting embodiments, transaction service provider system 102 may communicate a message (e.g., a transaction offset notification message) that includes the data associated with generating the transaction offset to issuer system 104, user device 106, merchant system 108-1, and/or merchant system 108-N.

In some non-limiting embodiments, transaction service provider system 102 may communicate data associated with a transaction offset to issuer system 104, user device 106 (e.g., a user associated with user device 106, a merchant associated with user device 106, and/or the like), merchant system 108-1, and/or merchant system 108-N. For example, transaction service provider system 102 may communicate a message (e.g., a transaction offset report message) that includes data associated with one or more transaction offsets that are available to be used by and/or that have been used by a user to issuer system 104, user device 106 (e.g., a user associated with user device 106, a merchant associated with user device 106, and/or the like), merchant system 108-1, and/or merchant system 108-N. In some non-limiting embodiments, the transaction offset report message may include the transaction offset application parameters of the one or more transaction offsets.

In some non-limiting embodiments, transaction service provider system 102 may communicate data associated with one or more transaction offsets that are available to be used by and/or that have been used by a user based on a user interface that is displayed by user device 106. For example, transaction service provider system 102 cause the user interface to be displayed by user device 106 where the user interface includes the data associated with the one or more transaction that are available to be used by and/or that have been used by a user. In some non-limiting embodiments, the user interface may include a merchant identification data associated with an identifier of merchant that generated a transaction offset, merchant location data associated with a merchant that generated a transaction offset, and/or transaction offset application parameters of one or more transaction offsets. In some non-limiting embodiments, the user interface may include one or more user selectable elements (e.g., a control element, a link, a hyperlink, a button, a label button, a radio button, a dropdown list, a menu, a toggle, a slider, a bar, a handle, a switch, a check box, a text box, an icon, a cursor, a pointer, an insertion point, and/or the like) associated with data associated with one or more transaction offsets. For example, the user interface may include a plurality of user selectable elements associated with each of a plurality of merchant categories of a plurality of merchants that generated the one or more transaction offsets.

In some non-limiting embodiments, issuer system 104 may receive the data associated with generating the transaction offset from transaction service provider system 102, and issuer system 104 may communicate the data to user device 106. In some non-limiting embodiments, issuer system 104 may communicate the data to user device 106 via a banking interface (e.g., an Internet banking interface, a mobile banking interface, and/or the like).

In some non-limiting embodiments, an issuer institution associated with issuer system 104 may include data associated with the transaction offset in a message (e.g., an account statement, a credit account statement, a debit account statement, an electronic account statement, a physical account statement, a paper statement, and/or the like) to a user associated with an account that was issued by the issuer institution. In some non-limiting embodiments, the issuer institution communicates the message to a user device (e.g., user device 106) associated with the user.

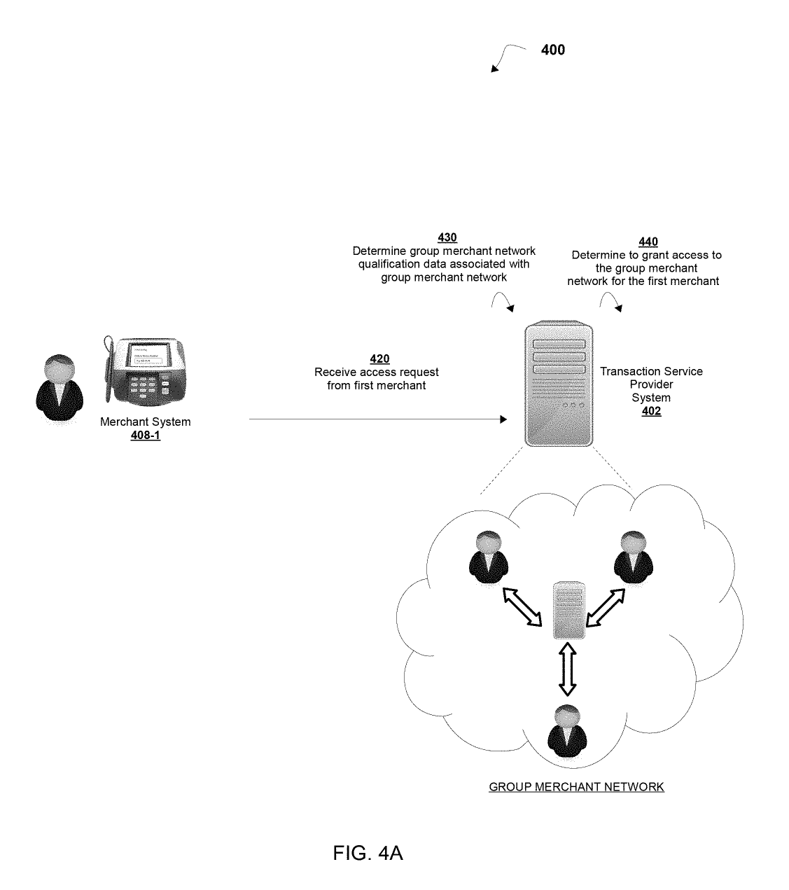

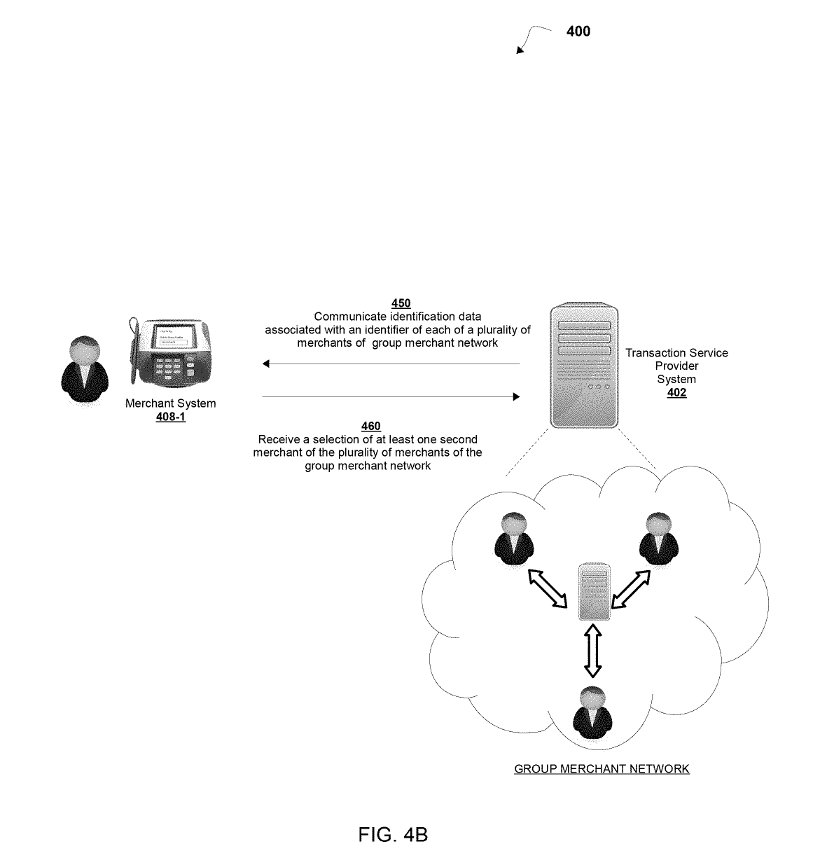

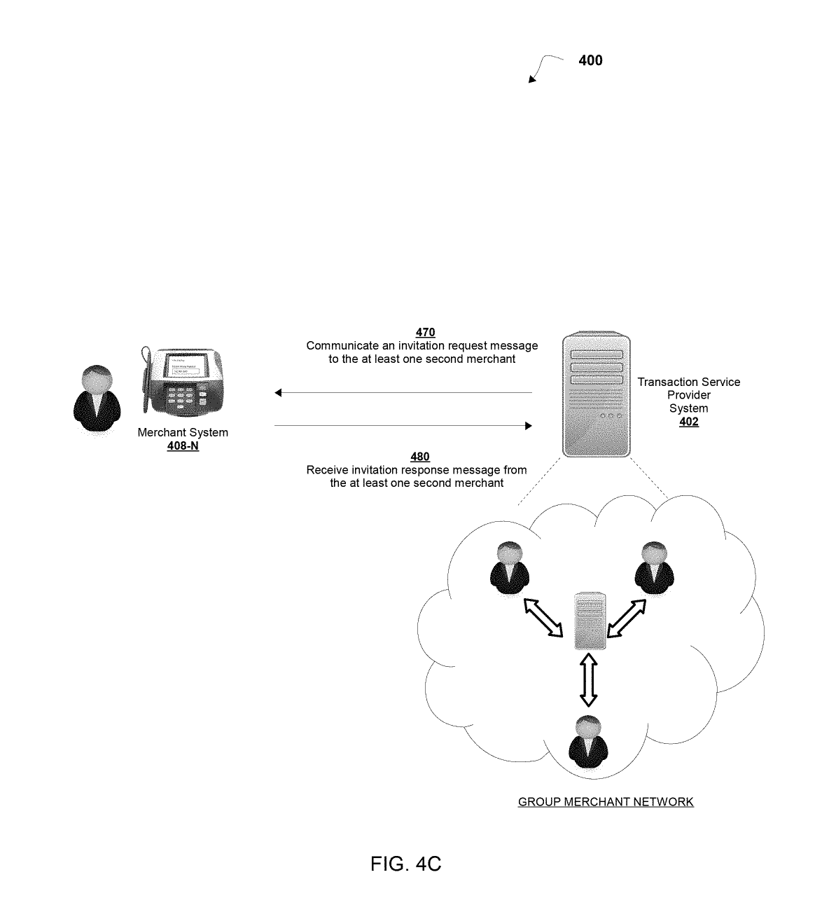

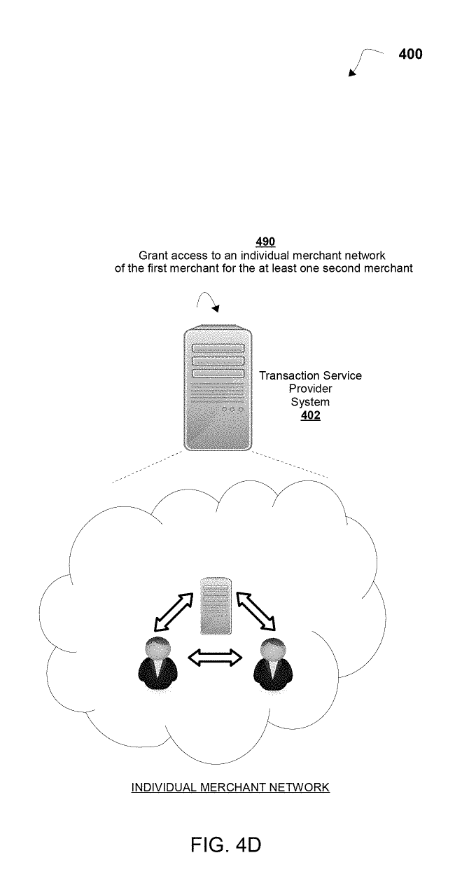

FIGS. 4A-4D are diagrams of an overview of a non-limiting embodiment of an implementation 400 relating to process 300 shown in FIG. 3. As shown in FIGS. 4A-4D, implementation 400 may include a transaction service provider system 402 and one or more merchant systems 408-1 through 408-N. As referred to herein, one or more of merchant systems 408-1 through 408-N may perform the same or similar functions as merchant systems 108 described above. Accordingly, merchant systems 408-1 through 408-N may be collectively referred to as “merchant systems 408”. In some non-limiting embodiments, transaction service provider system 402 may be the same or similar to transaction service provider system 102.

As shown by reference number 420 in FIG. 4A, transaction service provider system 402 may receive an access request from merchant system 408-1. In some non-limiting embodiments, the access request may include a request from the first merchant associated with merchant system 408-1 to join a group merchant network. As further shown by reference number 430 in FIG. 4A, transaction service provider system 402 may determine qualification data associated with the group merchant network for the first merchant. As further shown by reference number 440 in FIG. 4A, transaction service provider system 402 may determine to grant access to the group merchant network for the first merchant based on the qualification data.

As shown by reference number 450 in FIG. 4B, transaction service provider system 402 may communicate identification data associated with the identifier of each merchant of a plurality of merchants of the group merchant network based on determining to grant access to the group merchant network for the first merchant. As further shown by reference number 460 in FIG. 4B, transaction service provider system 402 may receive a selection of the identification data associated with a second merchant of the plurality of merchants.

As shown by reference number 470 in FIG. 4C, transaction service provider system 402 may communicate an invitation request message to merchant system 408-N associated with the second merchant. In some non-limiting embodiments, the invitation request message may include a request from the first merchant to the second merchant for the second merchant to join an individual merchant network of the first merchant. As further shown by reference number 480 in FIG. 4C, transaction service provider system 402 may receive an invitation response message from merchant system 408-N. In some non-limiting embodiments, the invitation response message may include an indication that the second merchant associated with merchant system 408-N will join the individual merchant network of the first merchant.

As shown by reference number 490 in FIG. 4D, transaction service provider system 402 may grant access to the individual merchant network of the first merchant for the second merchant. In some non-limiting embodiments, by granting access to the individual merchant network associated with the first merchant, transaction service provider system 402 may authorize the first merchant to cause the generation of a transaction offset associated with the second merchant and/or the second merchant to cause the generation of a transaction offset associated with the first merchant.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A computer-implemented method for providing a merchant-based social network for at least one merchant, the computer-implemented method comprising:
determining, with at least one processor, qualification data associated with a group merchant network for a first merchant based on an access request message from the first merchant;
determining, with at least one processor, whether to grant access to the group merchant network for the first merchant based on determining the qualification data associated with the group merchant network;
determining, with at least one processor, identification data associated with an identifier of at least one second merchant of the group merchant network based on at least one merchant alignment parameter;
communicating, with at least one processor, the identification data associated with the identifier of at least one second merchant based on determining the identification data associated with the identifier of at least one second merchant;
receiving, with at least one processor, a selection of the at least one second merchant;
communicating, with at least one processor, an invitation request message based on receiving the selection of the at least one second merchant, wherein the invitation request message comprises an invitation for the at least one second merchant to join an individual merchant network associated with the first merchant;
receiving, with at least one processor, an invitation response message after communicating the invitation request message, wherein the invitation response message comprises an indication that indicates whether the at least one second merchant will join the individual merchant network associated with the first merchant;
granting, with at least one processor, access to the individual merchant network associated with the first merchant for the at least one second merchant based on the invitation response message; and
wherein, by granting access to the individual merchant network associated with the first merchant:
the at least one second merchant is authorized to cause a transaction offset associated with the first merchant to be generated, or
the first merchant is authorized to cause a transaction offset associated with the at least one second merchant to be generated.

2. The computer-implemented method of claim 1, further comprising:
wherein determining the qualification data associated with the group merchant network comprises:
determining the qualification data associated with the group merchant network for the first merchant based on transaction data associated with a payment transaction involving the first merchant;
wherein determining whether to grant access to the group merchant network for the first merchant comprises:
comparing the qualification data to qualification criteria based on determining the qualification data;
determining that the qualification data corresponds to qualification criteria; and
determining to grant access to the group merchant network based on determining that the qualification data corresponds to qualification criteria.

3. The computer-implemented method of claim 1, further comprising:
communicating a notification message to the first merchant based on determining to provide access to the group merchant network for the first merchant,
wherein the notification message comprises at least one of:
group merchant network data associated with the first merchant,
merchant location restriction data associated with the first merchant,
merchant participation restriction data associated with the first merchant, or
any combination thereof.

4. The computer-implemented method of claim 1, further comprising:
receiving a search request message from the first merchant, wherein the search request message includes the at least one merchant alignment parameter.

5. The computer-implemented method of claim 1, further comprising:
receiving the at least one merchant alignment parameter from the first merchant; and
wherein determining the identification data associated with the identifier of the at least one second merchant of the group merchant network comprises:
determining the identification data associated with the identifier of at least one second merchant of the group merchant network based on receiving the at least one merchant alignment parameter from the first merchant.

6. The computer-implemented method of claim 5, wherein receiving the selection of the at least one second merchant comprises:
receiving the selection of the at least one second merchant after communicating the identification data associated with the identifier of at least one second merchant.

7. The computer-implemented method of claim 1, wherein granting access to the individual merchant network of the first merchant for the at least one second merchant comprises:
receiving authorization data from the first merchant, wherein the authorization data comprises an indication that the first merchant authorizes the at least one second merchant to generate a transaction offset associated with the first merchant based on transaction offset data associated with the transaction offset from the at least one second merchant.

8. The computer-implemented method of claim 7, wherein granting access to the individual merchant network of the first merchant for the at least one second merchant comprises:
receiving authorization data from the at least one second merchant, wherein the authorization data comprises an indication that the at least one second merchant authorizes the first merchant to generate a transaction offset associated with the at least one second merchant based on transaction offset data associated with the transaction offset from the first merchant.

9. The computer-implemented method of claim 1, wherein determining the identification data associated with the identifier of the at least one second merchant of the group merchant network comprises:
determining the identification data associated with the identifier of the at least one second merchant of the group merchant network based on the at least one merchant alignment parameter and the qualification data.

10. The computer-implemented method of claim 1, further comprising:
determining at least one of:
group merchant network data associated with the at least one second merchant,
merchant location restriction data associated with the at least one second merchant,
merchant participation restriction data associated with the at least one second merchant, or
any combination thereof; and
communicating, to the first merchant, at least one of:
group merchant network data associated with the at least one second merchant,
merchant location restriction data associated with the at least one second merchant,
merchant participation restriction data associated with the at least one second merchant, or
any combination thereof.

11. A system for providing a merchant-based social network for at least one merchant, the system comprising:
at least one processor programmed or configured to:
determine to grant access to a group merchant network for a first merchant based on qualification data associated with the group merchant network;
determine identification data associated with an identifier of each merchant of a plurality of merchants of the group merchant network based on at least one merchant alignment parameter;
communicate the identification data associated with the identifier of each merchant of the plurality of merchants of the group merchant network based on determining the identification data associated with an identifier of each merchant of a plurality of merchants of the group merchant network;
receive a selection of at least one second merchant of the plurality of merchants of the group merchant network;
communicate an invitation request message based on receiving the selection of the at least one second merchant, wherein the invitation request message comprises an invitation for the at least one second merchant to join an individual merchant network associated with the first merchant;
receive an invitation response message after communicating the invitation request message, wherein the invitation response message comprises an indication that indicates whether the at least one second merchant will join the individual merchant network associated with the first merchant;
grant access to the individual merchant network associated with the first merchant for the at least one second merchant based on the invitation response message; and
wherein, based on granting access to the individual merchant network associated with the first merchant, the at least one processor programmed or configured to:
authorize the at least one second merchant to cause a transaction offset associated with the first merchant to be generated, and
authorize the first merchant to cause a transaction offset associated with the at least one second merchant to be generated.

12. The system of claim 11, wherein the at least one processor is programmed or configured to:
communicate a notification message to the first merchant based on determining to provide access to the group merchant network for the first merchant,
wherein the notification message comprises at least one of:
group merchant network data associated with the first merchant,
merchant location restriction data associated with the first merchant,
merchant participation restriction data associated with the first merchant, or
any combination thereof.

13. The system of claim 11, wherein the at least one processor, when receiving the selection of the at least one second merchant, is programmed or configured to:
receive the selection of the at least one second merchant after communicating the identification data associated with the identifier of at least one second merchant.

14. The system of claim 11, wherein the at least one processor is programmed or configured to:
determine whether to generate a transaction offset based at least partially on transaction data associated with a payment transaction and at least one merchant redemption rule; and
generate the transaction offset based on determining to generate the transaction offset, wherein the transaction offset comprises transaction offset application parameters.

15. The system of claim 14, wherein the at least one merchant redemption rule comprises merchant redemption rule criteria, wherein the merchant redemption rule criteria comprises at least one of:
a threshold value associated with a transaction amount of a payment transaction,
a threshold value associated with a time of a payment transaction,
a threshold value of a number of payment transactions involving a customer and the first merchant,
group merchant network data associated with the at least one second merchant, or
any combination thereof.

16. A computer program product for providing a merchant-based social network for at least one merchant, the computer program product comprising at least one non-transitory computer-readable medium including one or more instructions that, when executed by at least one processor, cause the at least one processor to:
determine whether to grant access to a group merchant network for a first merchant based on qualification data associated with the group merchant network;
determine identification data associated with an identifier of each merchant of a plurality of merchants of the group merchant network based on at least one merchant alignment parameter;
communicate the identification data associated with the identifier of each merchant of a plurality of merchants of the group merchant network based on determining the identification data associated with the identifier of each merchant of a plurality of merchants of the group merchant network;
receive a selection of at least one second merchant of the plurality of merchants of the group merchant network;
communicate an invitation request message based on receiving the selection of the at least one second merchant, wherein the invitation request message comprises an invitation for the at least one second merchant to join an individual merchant network associated with the first merchant;
receive an invitation response message after communicating the invitation request message, wherein the invitation response message comprises an indication that indicates whether the at least one second merchant will join the individual merchant network associated with the first merchant;
grant access to the individual merchant network associated with the first merchant for the at least one second merchant based on the invitation response message; and
wherein, based on granting access to the individual merchant network associated with the first merchant, the one or more instructions further cause the at least one processor to:
authorize the at least one second merchant to cause a transaction offset associated with the first merchant to be generated, and
authorize the first merchant to cause a transaction offset associated with the at least one second merchant to be generated.

17. The computer program product of claim 16, wherein the one or more instructions further cause the at least one processor to:
determine to generate a transaction offset based at least partially on transaction data associated with a payment transaction and at least one merchant redemption rule; and
generate the transaction offset based on determining to generate the transaction offset, wherein the transaction offset comprises transaction offset application parameters.

18. The computer program product of claim 17, wherein the at least one merchant redemption rule comprises merchant redemption rule criteria, wherein the merchant redemption rule criteria comprises at least one of:
a threshold value associated with a transaction amount of a payment transaction,
a threshold value associated with a time of a payment transaction,
a threshold value of a number of payment transactions involving a customer and the first merchant,
group merchant network data associated with the at least one second merchant, or
any combination thereof.

19. The computer program product of claim 16, wherein the one or more instructions further cause the at least one processor to:
receive authorization data from the first merchant, wherein the authorization data comprises an indication that the first merchant authorizes the at least one second merchant to generate a transaction offset associated with the first merchant based on transaction offset data associated with the transaction offset from the at least one second merchant; and
generate the transaction offset based on receiving the authorization data from the first merchant.

20. The computer program product of claim 19, wherein the one or more instructions further cause the at least one processor to:
receive authorization data from the at least one second merchant, wherein the authorization data comprises an indication that the at least one second merchant authorizes the first merchant to generate a transaction offset associated with the at least one second merchant based on transaction offset data associated with the transaction offset from the first merchant; and
generate the transaction offset based on receiving the authorization data from the at least one second merchant.
